(19) United States
(12) Patent Application Publication
(10) Pub. No.: US 2025/0321722 A1
(43) Pub. Date: Oct. 16, 2025

(54) AUTOMATED CODE GENERATION FOR DYNAMIC DATA VISUALIZATION USING GENERATIVE AI

(71) Applicant: ETON SOLUTIONS, L.P., Morrisville, NC (US)

(72) Inventor: Muralidhran NADARAJAH, Durham, NC (US)

(21) Appl. No.: 19/034,315

(22) Filed: Jan. 22, 2025

Related U.S. Application Data
(60) Provisional application No. 63/623,705, filed on Jan. 22, 2024.

(51) Int. Cl. G06F 8/38; G06F 8/10; G06F 8/35

(52) U.S. Cl. CPC G06F 8/38; G06F 8/10; G06F 8/35

(57) ABSTRACT

A system for automating the creation of dynamic data visualizations using Generative AI and large language models (LLMs). The invention translates natural language inputs into intermediate code formats, including Mermaid, DAX, and VBA, enabling platform-specific visualizations. Features include template cloning, contextualization via knowledge graphs, and fine-tuning with AI, enhancing customization and efficiency in data reporting and analysis.

### CROSS-REFERENCE TO RELATED APPLICATIONS

This patent application is a non-provisional patent application based on and takes priority from U.S. provisional patent application Ser. No. 63/623,705 entitled Automated Code Generation for Dynamic Visualization Using Generative AI and filed on Jan. 22, 2024, which is incorporated by reference herein in its entirety.

### FIELD

Implementations disclosed herein relate, in general, to information management technology and specifically to artificial intelligence (AI) based systems.

### SUMMARY

The technology disclosed herein pertains to a novel system and method for the automated generation of code for the purpose of creating dynamic visualizations, particularly for data reporting. Leveraging the capabilities of Generative AI large language models (LLMs), the system translates English language inputs into various forms of executable code, including but not limited to mermaid code, DAX for Power BI, and Excel VBA.

The core innovation is a dual-process mechanism involving template cloning and subsequent AI-driven fine-tuning, specifically tailored to optimize visualizations for nuanced data representation. This mechanism distinctly improves the adaptability and precision of generated visualizations.

The proposed system distinguishes itself by enabling the creation of a broad spectrum of visual elements such as graphs, charts, and diagrams without the constraints of pre-set templates or configurations. This flexibility ensures that users can generate customized visualizations that cater to specific reporting requirements. creating visual representations of data flow, process diagrams, architecture diagrams, and other types of flowcharts, often within documentation. Additionally, the AI-driven approach eliminates the need for manual code development, streamlining the process of data representation and analysis in data contexts.

The practical applications of this technology disclosed herein are vast, offering enhanced efficiency and customization in data reporting and data analysis. By automating the creation of complex visualizations, this system not only saves time but also opens up new possibilities for data interpretation and presentation, making it a valuable tool in the field of data analytics and reporting.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1: (End-user experience) illustrates the end-to-end workflow for generating dynamic data visualizations using the system. This includes user inputs in the form of text and images, processing by a pre-trained large language model (LLM), intermediate visual code generation, and final customization using visualization tools.

FIG. 2: (LLM Clone Training) illustrates the workflow for training the large language model (LLM) using supervised fine-tuning, in-context learning, and reinforcement learning from human feedback (RLHF). The process integrates pre-trained models, prompt design, and feedback loops to optimize the model for accurate visual code generation.

FIG. 3: (Sample Outputs from Automated LLM Engine) provides an example of a markdown-based look-through visualization generated by the LLM. This diagram demonstrates how the system creates hierarchical representations of family data structures, showcasing variance in style and detail achieved through intermediate markdown code.

FIG. 4: (Sample Outputs from Automated LLM Engine) illustrates a complex, app-based look-through visualization of a family office's investment structures. The diagram highlights the system's ability to produce rich, interactive outputs tailored for specific user requirements, such as ownership hierarchies and multi-level data.

FIG. 5 illustrates a mobile device used to implement one or more components of the system disclosed herein.

FIG. 6 illustrates a computing device used to implement one or more components of the system disclosed herein.

### DETAILED DESCRIPTION

Traditional tools for data visualization often require manual coding and rely heavily on predefined templates, limiting the scope of customization and adaptability to complex data scenarios. These limitations necessitate significant time and expertise, restricting broader accessibility. This invention overcomes these challenges by automating visualization creation using LLMs, allowing users to input natural language descriptions for seamless code generation across diverse platforms.

A system for automating the creation of dynamic data visualizations using Generative AI and large language models (LLMs). The invention translates natural language inputs into intermediate code formats, including Mermaid, DAX, and VBA, enabling platform-specific visualizations. Features include template cloning, contextualization via knowledge graphs, and fine-tuning with AI, enhancing customization and efficiency in data reporting and analysis.

The invention provides a system for automating the creation of dynamic and customized data visualizations by combining advanced natural language processing (NLP) and multi-modal learning capabilities. One or more advantages and benefits provided by the system disclosed herein include:

Input Flexibility: Accepts both textual and visual inputs, enabling users to describe desired visualizations in natural language or provide examples for replication.

Advanced Interpretation: Utilizes transformer-based NLP models and multi-modal techniques to contextualize inputs, ensuring accurate understanding of user intent and data visualization scenarios.

Template Customization: Leverages AI-driven template cloning to create tailored visualizations that adapt to specific user requirements and datasets.

Platform-Agnostic Code Generation: Produces intermediate code formats (e.g., DAX, Mermaid, VBA) to maintain flexibility for users to refine and integrate visualizations into platforms like Power BI or Excel.

Dynamic Rendering: Transforms generated code into visual outputs, such as charts, graphs, and diagrams, allowing further customization through supported visualization tools.

Specifically, the system disclosed herein enhances efficiency, precision, and accessibility in data reporting by automating the traditionally manual and time-consuming process of visualization creation. It enables users, regardless of technical expertise, to generate highly customized, platform-specific visuals tailored to their unique data and analytical needs.

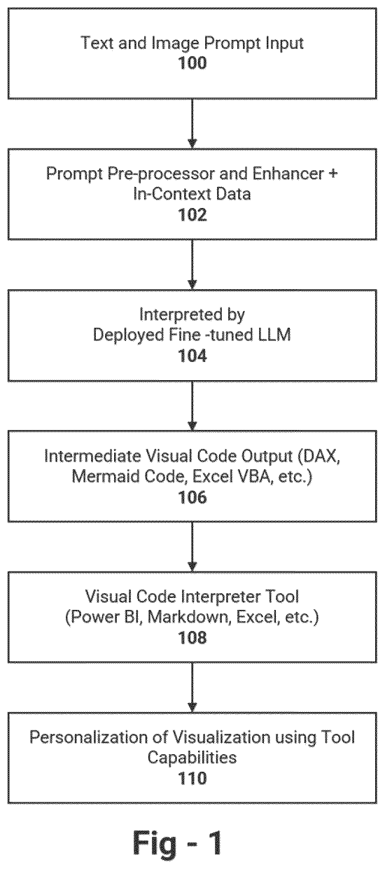

FIG. 1: (End-user experience) illustrates the end-to-end workflow for generating dynamic data visualizations using the system. This includes user inputs in the form of text and images, processing by a pre-trained large language model (LLM), intermediate visual code generation, and final customization using visualization tools.

Specifically, FIG. 1 provides a comprehensive workflow for creating dynamic, user-driven data visualizations using Generative AI. The process emphasizes automation, flexibility, and customization, transforming user inputs into tailored visual outputs through the following operations.

At operation 100 user input is received in response to text and image prompts. Specifically at operation 100, users initiate the process by entering natural language descriptions (e.g., “Generate a bar chart of Q3 sales by region”) or uploading images as visual examples of the desired output. These inputs capture user requirements, such as chart type, data categories, or stylistic preferences.

At operation 102 provides pre-processing and context enrichment. Specifically, at operation 102, a pre-processing module enhances user inputs to ensure clarity and compatibility with the system's interpretation models. Contextual information, including historical data or domain-specific knowledge, is integrated to refine the input and align it with the user's objectives.

An operation 104 provides interpretation by fine-tuned language model (LM), such as a large language model (LLM). Specifically, the system employs a fine-tuned Large Language Model (LLM) to process the enriched inputs. The LLM identifies the intent, extracts key parameters, and generates structured intermediate representations such as platform-specific instructions or code.

At operation 106, the system converts the interpreted data into intermediate, platform-agnostic code formats, such as DAX for Power BI visualizations, Mermaid for diagrams and flowcharts, Excel VBA for spreadsheet macros, etc. This approach facilitates platform-specific visualization while preserving user flexibility to make subsequent edits. An operation 108 renders visual code into visual outputs. Specifically, at operation 108, the intermediate code is processed by visualization tools (e.g., Power BI, Markdown editors, or Excel) to generate dynamic visual outputs, including charts, graphs, and interactive diagrams.

Subsequently, at operation 110, user driven customization is provided. Specifically, at operation 108, users finalize the visualization by leveraging built-in editing features of the target platform. Personalization options include adjusting chart elements (e.g., colors, labels, and data ranges), reorganizing layouts, or adding annotations to align with specific reporting needs.

The operations disclosed in FIG. 1 underscore the adaptability and efficiency of the system, enabling users with varying technical expertise to create sophisticated, real-time data visualizations with minimal manual intervention. By supporting iterative customization and multi-platform compatibility, the process enhances decision-making, communication, and analysis in data reporting.

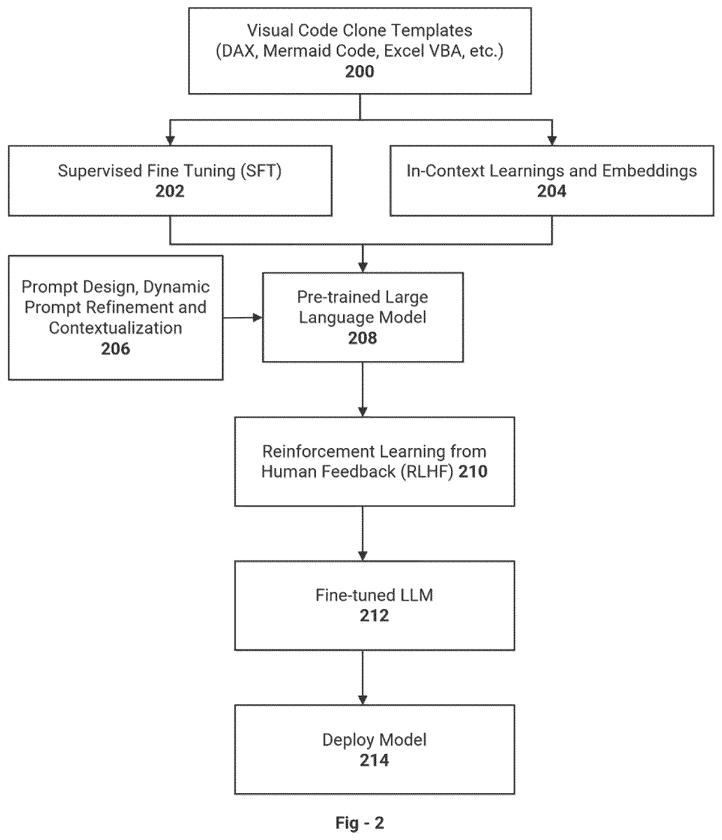

FIG. 2: (LLM Clone Training) illustrates the workflow for training the large language model (LLM) using supervised fine-tuning, in-context learning, and reinforcement learning from human feedback (RLHF). The process integrates pre-trained models, prompt design, and feedback loops to optimize the model for accurate visual code generation.

Specifically, FIG. 2 illustrates the systematic workflow for training and deploying the Large Language Model (LLM) used in the automated code generation system. This process ensures that the LLM is fine-tuned and optimized for generating accurate and customizable data visualization code.

An operation 200 provides visual code clone templates. Specifically, the operation 200 begins with a repository of pre-existing visual code templates in formats such as DAX, Mermaid, and Excel VBA. These templates serve as the foundational structures. for generating visualizations.

An operation 202 provides supervised fine-tuning (SFT). Specifically, at the operation 202 the templates are fine-tuned using supervised learning methods. This process involves training the model with labeled datasets to optimize its ability to generate accurate and context-aware code outputs based on user prompts.

An operation 204 provides in-context learnings and embeddings. Specifically, the operation 204 provides contextual data, such as user intent and domain-specific knowledge, is embedded into the model. This enhances its ability to understand nuanced user inputs and generate code tailored to specific scenarios.

An operation 206 provides prompt design, dynamic prompt refinement and contextualization. Specifically, the operation 206 focuses on creating effective prompts for the pre-trained LLM. These prompts act as guides, ensuring the model interprets user input accurately and aligns with the desired outcomes. In addition, since the prompt Input is multi-modal, sample diagrams of what is required is submitted as part of the refined prompt.

An operation 208 provides pre-trained large language model. Specifically, the operation 208 leverages a pre-trained LLM as the base model, which has been trained on diverse datasets. It serves as the foundation for further fine-tuning and reinforcement learning.

An operation 210 provides reinforcement learning from human feedback (RLHF). Specifically, the operation 210 incorporates reinforcement learning techniques, leveraging human feedback to improve the model's performance iteratively. Feedback from users ensures the model aligns with real-world expectations and generates more accurate code.

An operation 212 provides a fine-tuned LLM. Specifically, after completing the supervised fine-tuning and reinforcement learning operations, at the operation 212 the LLM is fine-tuned for optimal performance in the specific domain of data visualization.

An operation 214 deploys the model. Specifically, at operation 214 the fine-tuned model is deployed for use in the system, enabling end-users to generate dynamic and customizable visualizations through their prompts.

The operations disclosed in FIG. 2 provide a number of technical benefits including template-driven learning that ensures that the system can replicate common data visualizations with high fidelity while allowing customization for unique user requirements, iterative optimization that combines supervised learning and reinforcement learning for continuous improvement, ensuring the model adapts to evolving user needs, and multi-modal capabilities that integrates textual and visual data into training, enhancing flexibility and usability across diverse data reporting scenarios.

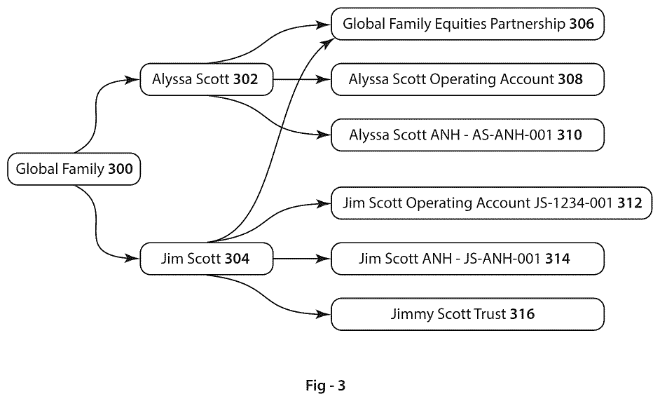

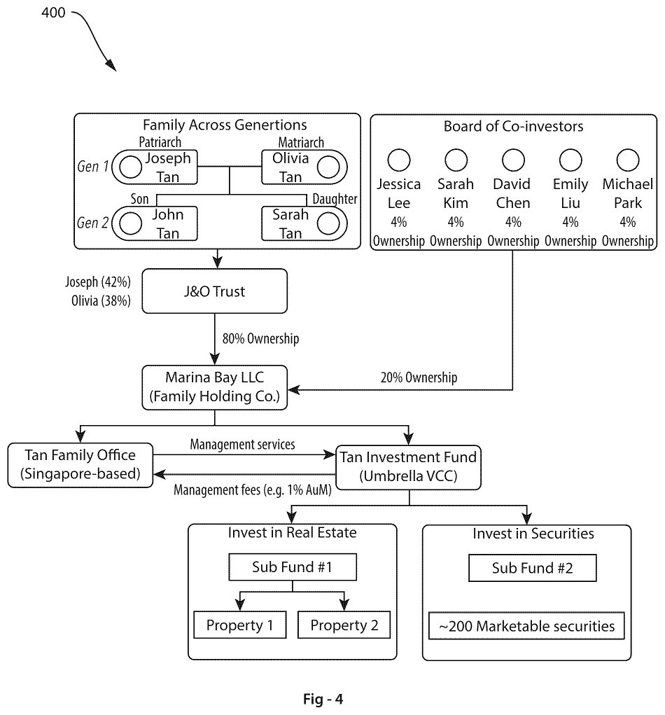

FIG. 3 and FIG. 4 illustrate examples of look-through visualization diagrams, emphasizing the flexibility and variance achievable in visual representation using the patented system. These diagrams demonstrate how clones and intermediate outputs can be leveraged to meet diverse user expectations.

FIG. 3: (Sample Outputs from Automated LLM Engine) provides an example of a markdown-based look-through visualization generated by the LLM. This diagram demonstrates how the system creates hierarchical representations of family data structures, showcasing variance in style and detail achieved through intermediate markdown code.

Specifically, FIG. 3 illustrates a family look-through diagram using markdown. It demonstrates the system's capability to generate a markdown-based hierarchical visualization of data, emphasizing simplicity, adaptability, and user-driven customization. This diagram showcases the connection between the workflows described in FIG. 1 (End-User Experience) and FIG. 2 (Training Workflow for Visual Code Generation).

As illustrated, the system disclosed herein outputs a hierarchical markdown-based visualization that represents a family data structure. For example, the global family 300 is the root node. The family diagram includes key family members, such as Alyssa Scott (302) and Jim Scott (304), who are connected to their respective entities, including Global Family Equities Partnership (306), operating accounts (308, 312), ANH—AS-ANH-001 (310, 314), and Trust (316). This approach showcases how structured intermediate code (e.g., Mermaid) is leveraged to generate a look-through diagram that visualizes complex relationships between entities.

As referred in FIG. 1, users initiate this output by providing inputs such as “Generate a hierarchical chart showing family investments and accounts.” The LLM interprets user prompts (Operation 104) and translates them into intermediate markdown-based code (Operation 106), allowing for platform-agnostic visualization. Furthermore, as illustrated in FIG. 2, training on pre-existing templates (Operation 200) enables the system to generate precise markdown structures. Furthermore, fine-tuning with domain-specific feedback (Operations 202, 210) ensures accurate hierarchy representation, accommodating diverse customer setups.

The customization and flexibility provided by the family look-through diagram include a mark-down format that allows users to adjust the node layout, relationships, and annotations easily. Example, of the customization include adding new accounts or trust nodes, modifying labels to reflect current customer statuses, etc. The lightweight markdown-based output is ideal for scenarios requiring quick visualization with minimal computational overhead, such as internal reports or collaboration on text-based platforms.

FIG. 4: (Sample Outputs from Automated LLM Engine) illustrates a complex, app-based look-through visualization of a family office's investment structures. The diagram highlights the system's ability to produce rich, interactive outputs tailored for specific user requirements, such as ownership hierarchies and multi-level data.

Specifically, FIG. 4 highlights the system's capability to generate interactive, app-based visualizations for complex, multi-tier data scenarios. It reinforces the enhanced precision and flexibility made possible through the workflows described in FIG. 1 and FIG. 2. The illustrated FIG. 4 is an output generated by the system that provides a sophisticated visualization 400 of a multi-generational family office and its informational data structures. For example, the visualization 400 includes a trust, such as a central holding company, as the primary node, subsidiary entities such as Marina bay LLC (a family holding company) and its ownership distribution, ten Family Office services, including management fees and real estate investments, sub-funds representing distinct asset classes (e.g., real estate and securities), etc. While FIG. 4 illustrates the visualization 400 for investments, alternatively, it can used to provide visualization for data owned by various entities, etc.

As illustrated in FIG. 1, inputs such as “Show detailed investment ownership structures for the family office” are processed by the LLM (Operation 104) to generate intermediate app-specific code. Furthermore, intermediate outputs (Operation 106) are tailored for interactive platforms, enabling users to manipulate ownership percentages, hierarchical layers, and asset groupings.

As illustrated in FIG. 2, templates for complex look-through structures (Operation 200) ensure that the system can replicate nuanced investment hierarchies. Furthermore, reinforcement learning from feedback (Operation 210) refines the system to account for interdependencies like multi-level ownership and varying investment categories.

Users may customize app-based visualizations by adding dynamic data layers such as ownership percentages or asset types or by enabling interactive elements like clickable nodes for real-time exploration of investment details. These capabilities provide a richer, more granular view than markdown-based diagrams. These provides applications that are suitable for high-stakes scenarios like investment management, compliance reporting, and risk analysis. For example, a family office manager uses the app to present detailed visualizations of asset allocations and performance metrics to stakeholders.

The system disclosed herein, including FIGS. 1 and 2 demonstrate how to seamlessly transforms user inputs into tailored visualizations, accommodating different complexity levels and output formats. Furthermore, the quality and adaptability of these outputs are underpinned by the robust training process, including template-driven learning, fine-tuning, and reinforcement learning. On the other hand, FIG. 3 highlights lightweight, text-compatible outputs for quick implementation, whereas FIG. 4 showcases data-rich, interactive visualizations tailored for detailed analyses and stakeholder presentations.

As illustrated, the technology disclosed herein automates the creation of dynamic data visualizations by integrating natural language processing (NLP), multi-modal learning, and generative AI techniques. It leverages an advanced workflow that processes user inputs, contextualizes them, and outputs platform-specific, customizable code formats. This section outlines the core components and operational workflow of the system.

In an alternative implementation, the system disclosed herein includes the following components:

An input module accepts natural language inputs (e.g., “Create a bar chart of Q3 revenue”) and optional visual inputs, such as images or sketches of desired outcomes and incorporates models to process and align text and visual data for improved interpretability.

An NLP and a multi-modal learning module processes user inputs using transformer-based models to extract intent and contextual meaning and jointly embeds text and visual inputs to ensure a unified understanding of user requirements.

A template cloning and contextualization module Clones and customizes visualization templates to fit user-specific data scenarios and uses AI-driven techniques, such as knowledge graphs, to ensure the visualizations are contextually relevant.

A code generation engine translates processed inputs into intermediate, platform-agnostic code formats, including DAX for Power BI visualizations, Mermaid for flowcharts and diagrams, and Excel VBA for spreadsheet macros.

A visualization renderer interprets generated code to produce visual outputs such as charts, graphs, and interactive diagrams and supports real-time customization, allowing users to adjust styling, layout, and other elements.

The operational workflow of the system disclosed herein includes the following operations:

During a user input processing operation, users provide textual descriptions or visual examples of desired outputs, and the input module ensures that the data is preprocessed and aligned with system requirements.

Subsequently, during an interpretation and contextualization operation, the NLP and multi-modal learning module interprets the inputs, identifying key attributes such as chart type, data categories, and stylistic preferences and the contextualization leverages prior knowledge (e.g., customer history or predefined rules) to enhance accuracy.

During a template selection and customization operation, the system identifies the most suitable visualization template and tailors it based on user intent and contextual data.

Subsequently, during an intermediate code generation operation the code generation engine outputs platform-specific code formats, ensuring compatibility with visualization tools like Power BI or Excel. During this operation, the intermediate code maintains flexibility, enabling users to make iterative adjustments.

Finally, during a rendering and final customization operation the generated code is rendered into visual outputs using visualization platforms and the users refine outputs through platform tools, customizing colors, labels, and layouts as needed.

The system disclosed herein provides a number of advantages. For example, the system is flexible in that the platform-agnostic approach allows users to generate and customize visualizations across multiple tools. The system provides efficiency by automating Automates traditionally manual processes, reducing the time and expertise required for data visualization. It also provides enhanced accessibility by empowering non-technical users to create complex visualizations through simple inputs. Additionally, the system allows customization that offers users control over visualization style, structure, and detail, surpassing template-based limitations. The real-time adaptation of the system updates outputs dynamically based on evolving datasets and user inputs.

Example applications of the system disclosed herein include data reporting, such as data reporting, by automating creation of revenue breakdowns, cost analyses, and investment structures. It also allows providing intelligence dashboards by generating interactive charts that integrate real-time data for strategic decision-making. Users can manage portfolio of assets that allows visualization of asset allocations, risk models, and performance metrics, tailored for stakeholder presentations.

Thus, the technology disclosed herein provides innovative use of generative AI and intermediate code to revolutionize data visualization workflows. It bridges the gap between user intent and dynamic, customized outputs, redefining the process of data representation in data contexts.

An example implementation of the system disclosed herein provides a system for automated code generation for dynamic data visualization as further disclosed below in claims 1-15. Specifically, the system or method recited in claims 1, 2, and 13 provide the ability to process both textual and visual inputs, ensuring the system adapts to diverse user needs. The system or method recited in claims 1, 2, 5, and 9 provide the ability of platform-agnostic intermediate code, enabling flexibility across visualization tools. The system or method recited in claims 10, 11, and 15 provide adaptability for iterative refinements and live data synchronization. The system or method recited in claims 8 and 14 provide reinforcement learning techniques employed for improving model accuracy.

The system or method recited in claims as well as the implementations disclosed herein provide a number of advantages over the existing solutions. Specifically, they improve upon existing solutions for data visualization by addressing their limitations in flexibility, efficiency, and accessibility. Key advantages include the following:

Enhanced Customization Beyond Templates: Unlike traditional tools limited by static, predefined templates, this system dynamically customizes visualizations to align with user-specific requirements. Furthermore, intermediate code generation enables users to tailor visual outputs—such as graphs, charts, and diagrams—to unique data scenarios without requiring extensive technical expertise.

Efficiency and Automation: The system disclosed herein automates the labor-intensive process of manual coding for data visualizations, reducing the time and skill required for data representation and seamlessly transforms natural language and visual inputs into executable code, enabling rapid generation of complex, multi-layered visualizations.

Versatility Across Platforms and Formats: The system disclosed herein supports multiple intermediate code formats (e.g., DAX for Power BI, Mermaid for diagrams, Excel VBA for macros), ensuring compatibility with diverse visualization tools. Furthermore, the platform-agnostic outputs allow users to integrate and refine visualizations directly within their preferred tools.

Multi-Modal Input Capability: The system disclosed herein processes both textual and visual inputs, enabling users to describe desired outputs in natural language or provide visual examples for replication and it combines advanced NLP with visual data processing (e.g., image embeddings) to deliver precise, context-aware visualizations.

Real-Time Adaptation and Interactivity: The system disclosed herein enables dynamic updates to visualizations as datasets evolve, providing real-time insights for decision-making and facilitates interactivity through features like adjustable nodes, live data overlays, and clickable elements, enhancing user engagement.

Accessibility for Non-Technical Users: The system disclosed herein empowers users without coding expertise to create professional-grade data visualizations through simple natural language commands. Furthermore, the guided workflows and customization options simplify complex visualization tasks, making advanced tools accessible to a broader audience.

Scalability and Continuous Improvement: The system disclosed herein employs advanced machine learning techniques, including reinforcement learning from human feedback, to continually refine model performance and its scalable architecture ensures consistent performance across varying levels of data complexity and visualization requirements.

Broader Applications: The system disclosed herein supports a wide range of use cases, including data reporting, business intelligence, investment management, compliance analysis, and risk assessment and it is tailored outputs accommodate both lightweight markdown-based visuals and rich, interactive app-based representations.

This invention redefines the standards for data visualization tools by providing unparalleled flexibility, efficiency, and user-friendliness. It bridges the gap between manual coding and advanced visualization, offering a scalable, automated, and accessible solution that meets the needs of modern data analysis.

The disclosed system redefines data visualization by automating code generation using Generative AI, bridging the gap between user intent and visual output through advanced NLP and multi-modal learning. Its innovative approach offers unprecedented flexibility, efficiency, and depth in data reporting.

The technology disclosed herein may be applied to a number of industries, including financial data analysis and reporting where it enhances the ability of analysts to create detailed, customized reports quickly, incorporating both textual and visual data, for investment management where it assists portfolio managers in visualizing asset allocations, performance metrics, and risk assessments with enriched visual information, in accounting and auditing where it streamlines the generation of financial statements, variance analyses, and compliance reports, utilizing historical visual data, in risk management where it enables the visualization of complex risk models and simulations, integrating visual inputs for comprehensive understanding, in business intelligence and analytics where it integrates with BI tools to provide dynamic, interactive dashboards that leverage both textual and visual data, and for educational and training programs where it aids in creating instructional materials with customized visualizations for finance education.

Furthermore, the technology disclosed herein provides technical advantages by streamlining visual development by automating creation of complex visualizations, saving time and resources and enhancing efficiency for professionals working with time-sensitive and complex data. The technology disclosed herein also provides a high degree of customization with visual integration such that users can tailor visualizations to specific reporting needs, including styling, interactivity, and visual data and it supports diverse visualization types and platforms. Additionally, the technology disclosed herein enhances the scope of visualization as it is capable of producing traditional and complex multi-dimensional visualizations and as it illustrates intricate financial correlations and forecasts effectively, incorporating visual trends. The technology disclosed herein also provides natural language and visual inputs make the system accessible to users without coding skills and guided interfaces that provide operation-by-operation assistance. Additionally, the technology disclosed herein supports real-time updates and modifications based on dynamic datasets and visual inputs that are important for fast-paced data environments. In addition, the technology disclosed herein provides tools for comprehensive information retrieval that combines textual and visual data for richer outputs and improves the relevance and depth of generated visualizations.

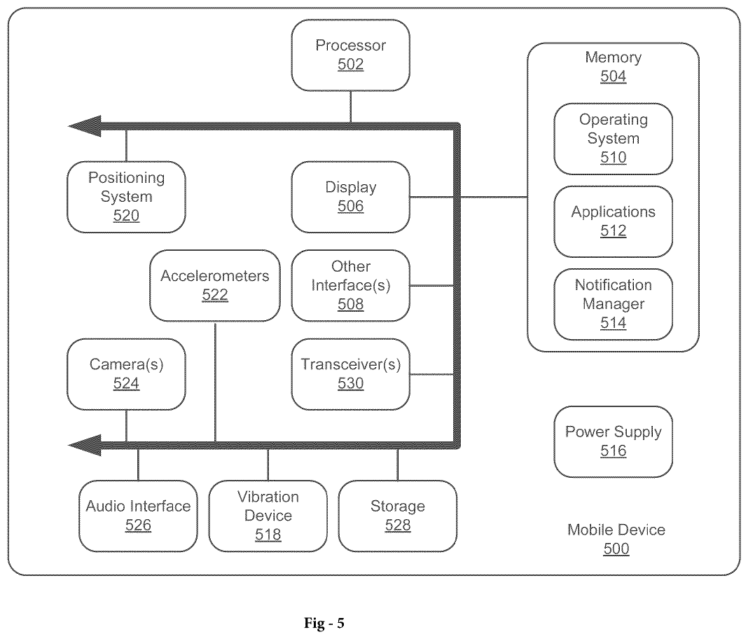

FIG. 5 illustrates a mobile device 500 used to implement one or more components of the system disclosed herein.

The mobile device 500 includes a processor 502, a memory 504, a display 506 (e.g., a touchscreen display), and other interfaces 508 (e.g., a keyboard). The memory 504 generally includes both volatile memory (e.g., RAM) and non-volatile memory (e.g., flash memory). An operating system 510, such as the Microsoft Windows® Phone operating system, resides in the memory 504 and is executed by the processor 502, although it should be understood that other operating systems may be employed.

One or more application programs 512 are loaded in the memory 504 and executed on the operating system 510 by the processor 502. Examples of applications 512 include without limitation email programs, scheduling programs, personal information managers, Internet browsing programs, multimedia player applications, etc. A notification manager 514 is also loaded in the memory 504 and is executed by the processor 502 to present notifications to the user. For example, when a promotion is triggered and presented to the shopper, the notification manager 514 can cause the mobile device 500 to beep or vibrate (via the vibration device 518) and display the promotion on the display 506.

The mobile device 500 includes a power supply 516, which is powered by one or more batteries or other power sources and which provides power to other components of the mobile device 500. The power supply 516 may also be connected to an external power source that overrides or recharges the built-in batteries or other power sources.

The mobile device 500 includes one or more communication transceivers 530 to provide network connectivity (e.g., mobile phone network, Wifi®, BlueTooth®, etc.). The transceiver 530 may be configured to communicate with an NFC tag 509. The mobile device 500 also includes various other components, such as a positioning system 520 (e.g., a global positioning satellite transceiver), one or more accelerometers 522, one or more cameras 524, an audio interface 526 (e.g., a microphone, an audio amplifier and speaker and/or audio jack), and additional storage 528. Other configurations may also be employed.

In an example implementation, a mobile operating system, various applications, and other modules and services may be embodied by instructions stored in memory 504 and/or storage devices 528 and processed by the processing unit 502. User preferences, service options, and other data may be stored in memory 504 and/or storage devices 528 as persistent datastores.

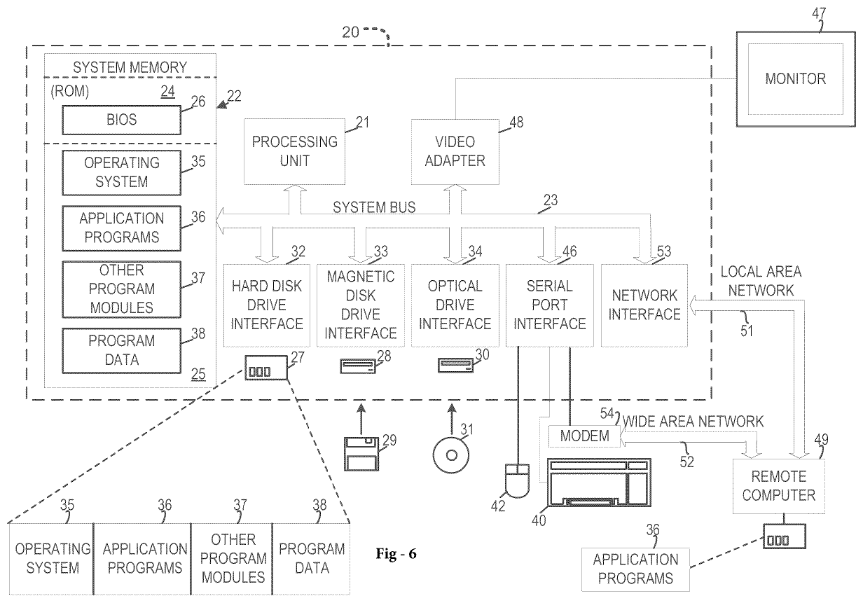

FIG. 6 illustrates an example system that may be useful in implementing the described technology. The example hardware and operating environment of FIG. 6 for implementing the described technology includes a computing device, such as general-purpose computing device in the form of a gaming console or computer 20, a mobile telephone, a personal data assistant (PDA), a set top box, or other type of computing device. In the implementation of FIG. 24, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the implementations are not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory and includes read only memory (ROM) 24 and random-access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide nonvolatile storage of computer-readable instructions, data structures, program modules and other data for the computer 20. It should be appreciated by those skilled in the art that any type of tangible computer-readable media which can store data that is accessible by a computer, such as magnetic cassettes, flash memory cards, digital video disks, random access memories (RAMs), read only memories (ROMs), and the like, may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the implementations are not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 24. The logical connections depicted in FIG. 24 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of and communications devices for establishing a communications link between the computers may be used.

In an example implementation, software or firmware instructions and data for providing a search management system, various applications, search context pipelines, search services, service, a local file index, a local or remote application content index, a provider API, a contextual application launcher, and other instructions and data may be stored in memory 22 and/or storage devices 29 or 31 and processed by the processing unit 21.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

The implementations described herein are implemented as logical operations in one or more computer systems. The logical operations may be implemented (1) as a sequence of processor-implemented operations executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, operations, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary implementations. Since many implementations can be made without departing from the spirit and scope of the claimed invention, the claims hereinafter appended define the invention. Furthermore, structural features of the different examples may be combined in yet another implementation without departing from the recited claims.

Embodiments of the present technology are disclosed herein in the context of an electronic market system. In the above description, for the purposes of explanation, numerous specific details are set forth in order to provide a thorough understanding of the present invention. It will be apparent, however, to one skilled in the art that the present invention may be practiced without some of these specific details. For example, while various features are ascribed to particular embodiments, it should be appreciated that the features described with respect to one embodiment may be incorporated with other embodiments as well. By the same token, however, no single feature or features of any described embodiment should be considered essential to the invention, as other embodiments of the invention may omit such features.

In the interest of clarity, not all of the routine functions of the implementations described herein are shown and described. It will, of course, be appreciated that in the development of any such actual implementation, numerous implementation-specific decisions must be made in order to achieve the developer's specific goals, such as compliance with application—and business-related constraints, and that those specific goals will vary from one implementation to another and from one developer to another.

According to one embodiment of the present invention, the components, process operations, and/or data structures disclosed herein may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment of the present invention, the components, processes and/or data structures may be implemented using machine language, assembler, C or C++, Java and/or other high level language programs running on a data processing computer such as a personal computer, workstation computer, mainframe computer, or high performance server running an OS such as Solaris® available from Sun Microsystems, Inc. of Santa Clara, California, Windows Vista™, Windows NT®, Windows XP PRO, and Windows® 2000, available from Microsoft Corporation of Redmond, Washington, Apple OS X-based systems, available from Apple Inc. of Cupertino, California, or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general-purpose machines; and. In addition, those of ordinary skill in the art will recognize that devices of a less general-purpose nature, such as hardwired devices, field programmable gate arrays (FPGAs), application specific integrated circuits (ASICs), or the like, may also be used without departing from the scope and spirit of the inventive concepts disclosed herein.

In the context of the present invention, the term “processor” describes a physical computer (either stand-alone or distributed) or a virtual machine (either stand-alone or distributed) that processes or transforms data. The processor may be implemented in hardware, software, firmware, or a combination thereof.

In the context of the present technology, the term “data store,” also referred to by the term “repository,” describes a hardware and/or software means or apparatus, either local or distributed, for storing digital or analog information or data. The term “data store” describes, by way of example, any such devices as random access memory (RAM), read-only memory (ROM), dynamic random access memory (DRAM), static dynamic random access memory (SDRAM), Flash memory, hard drives, disk drives, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “data store” also describes, by way of example, databases, file systems, record systems, object-oriented databases, relational databases, SQL databases, audit trails and logs, program memory, cache and buffers, and the like.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understood that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method for automated code generation for dynamic data visualization, comprising:
receiving multi-modal user inputs, including textual descriptions and visual examples;
interpreting inputs using a natural language processing module and multi-modal learning techniques;
cloning and customizing visualization templates to align with user requirements and data scenarios;
generating intermediate platform-agnostic code formats, including but not limited to DAX, Mermaid, and Excel VBA; and
rendering visualizations from the generated code while enabling users to refine outputs using platform-specific tools.

2. The method of claim 1, further comprising incorporating contextual data, such as data history or predefined user rules, into the interpretation of inputs to enhance accuracy.

3. The method of claim 1, wherein template customization is optimized through reinforcement learning techniques, leveraging feedback from users to improve the accuracy of generated visualizations.

4. The method of claim 1, wherein the intermediate code generation process supports the creation of both hierarchical and interactive visualizations.

5. The method of claim 1, further comprising processing visual inputs, such as sketches or screenshots, to extract structural and stylistic preferences for visualization generation.

6. A system for automated code generation for dynamic data visualization, comprising:
An input module configured to receive multi-modal inputs, including natural language descriptions and visual data;
A natural language processing (NLP) and multi-modal learning module configured to interpret user inputs, combining text and visual data into a unified contextual representation;
A template cloning and contextualization module configured to identify and customize visualization templates based on user intent and data context;
A code generation engine configured to produce intermediate code formats compatible with multiple visualization platforms, including DAX, Mermaid, and Excel VBA; and
A visualization rendering module configured to generate customizable visualizations by interpreting intermediate code, enabling real-time updates and user refinements.

7. The system of claim 6, wherein the multi-modal learning module includes a transformer-based model trained to jointly embed text and visual data for improved interpretability.

8. The system of claim 6, wherein the template cloning module leverages knowledge graphs to contextualize and adapt templates to specific datasets and user scenarios.

9. The system of claim 6, wherein the code generation engine is configured to generate intermediate code that supports user-driven customization without requiring significant technical expertise.

10. The system of claim 6, wherein the visualization rendering module integrates with third-party platforms, including Power BI, Markdown editors, and Excel, to generate visualizations.

11. The system of claim 6, wherein real-time updates are enabled by synchronizing visualizations with live data streams.

12. The system of claim 6, wherein the system enables iterative refinements by allowing users to adjust parameters such as chart types, labels, and data ranges directly within supported platforms.

13. The system of claim 6, wherein the visualization rendering module supports the generation of multi-layered visualizations, including hierarchical look-through diagrams and investment structure representations.

14. The system of claim 6, wherein the NLP module is fine-tuned using supervised learning and reinforcement learning from human feedback to ensure alignment with real-world data use cases.

15. The system of claim 6, wherein the generated visualizations include interactive elements such as clickable nodes or real-time data overlays, enhancing user engagement.
